(19) United States
(12) Patent Application Publication
(10) Pub. No.: US 2026/0134297 A1
(43) Pub. Date: May 14, 2026

(54) TECHNIQUES FOR GROUNDING LARGE LANGUAGE MODEL OUTPUT BASED ON GUIDED CONTEXT

(71) Applicant: Microsoft Technology Licensing, LLC, Redmond, WA (US)

(72) Inventors: Xiaofeng ZHU, Bothell, WA (US); Jaya Krishna Mandivarapu, Ball Ground, GA (US); Venkatasatya Premnath Ayyalasomayajula, Sammamish, WA (US)

(21) Appl. No.: 19/020,805

(22) Filed: Jan. 14, 2025

Related U.S. Application Data
(60) Provisional application No. 63/718,340, filed on Nov. 8, 2024.

(51) Int. Cl. G06N 5/02

(52) U.S. Cl. CPC G06N 5/02

(57) ABSTRACT

Described are examples for grounding text generation output from a generative artificial intelligence (GAI) model. In one example, an output of generated text in response to a natural language prompt can be received from a GAI model. A first graph including a first set of knowledge triplets can be generated from the output of the generated text. A grounded text output can be generated based on comparing the first graph to a second graph including a second set of knowledge triplets generated from a guided context related to a domain of the natural language prompt. In another example, a dual decoder can be used to separately process the natural language prompt and the guided context as inputs to a cross-attention calculation to improve the generated text output from the GAI model.

### CLAIM OF PRIORITY UNDER 35 U.S.C. § 119

The present application for patent claims priority to Provisional Patent Application No. 63/718,340, entitled “TECHNIQUES FOR GROUNDING LARGE LANGUAGE MODEL OUTPUT BASED ON GUIDED CONTEXT” filed Nov. 8, 2024, which is assigned to the assignee hereof and hereby expressly incorporated by reference herein for all purposes.

### BACKGROUND

Large language models (LLMs) in machine learning (ML) can generate text and perform various language-related tasks including responding to natural language prompts. Though useful, LLMs presents various challenges while performing these operations including performance issues, cost issues, accuracy issues, and the like.

Adapting an LLM to a specific domain is challenging for several reasons. First, pre-trained LLMs cover general knowledge and cannot access private data (even during fine-tuning) due to privacy, copyright, and policy constraints. Second, the grounding of generated texts can change depending on specific contexts, such as domain or timestamp. Recent studies mostly focus on detecting hallucinations and using multiple sequential LLM executions when hallucinations occur. Hallucinations can refer to generated texts from LLMs that may not match the true source content, and/or where the facts presented by the model cannot be verified from the source. These drawbacks remain significant hurdles in applying LLMs to real-world, business-critical, and vitally important applications. Third, business logic and structured data, such as databases and private knowledge bases, are required when integrating customized LLMs into production systems and presenting them to customers or users.

Some techniques exist to improve accuracy (correctness and providing grounding) of the text generated from an LLM, such as retrieval augmented generation (RAG), other types of fine tuning, etc., but such techniques alone may not overcome hallucinations. Some solutions have proposed to concatenate natural language prompts with a RAG context as input to the LLM, but enlarging the LLM input in this regard may result in increased memory processing and/or cost associated with using the LLM.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, a method for grounding text generation output from a generative artificial intelligence (GAI) model is provided that includes receiving, from the GAI model, an output of generated text in response to a natural language prompt, generating, from the generated text, a first graph including a first set of knowledge triplets, and generating a grounded text output based on comparing the first graph to a second graph including a second set of knowledge triplets generated from a guided context related to a domain of the natural language prompt.

In a further aspect, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a schematic diagram of an example of a device for performing functions related to providing grounding for large language model (LLM) generated text, in accordance with aspects described herein.

FIG. 2 is a flow diagram of an example of a method for generating, for a natural language prompt, grounded text output from a LLM based on a guided context, in accordance with aspects described herein.

FIG. 3 illustrates an example of a LLM that utilizes multiple decoders to generate text output, in accordance with aspects described herein.

FIG. 4 is a schematic diagram of an example of a device for performing functions described herein, in accordance with aspects described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes various examples related to providing grounding for output of generative artificial intelligence (GAI) models, such as large language models (LLMs), by correcting hallucinations that may occur with conventional models. Hallucinations may occur where LLMs, while proficient at producing fluent outputs for diverse user queries, can generate text that at least partially lacks faithfulness, factuality, or reasoning, though presented with a confident tone. In an example, post-processing can be performed on generated text that is output from an LLM using knowledge triplets from the natural language prompt on which the output is based and from a guided context to correct hallucinations. In another example, guided text generation can be provided for the LLM using multiple decoders-one decoder for the natural language prompt on which the output is to be based, and/or one decoder for a guided context in a domain related to the natural language prompt.

The guided context can include, for example, a retrieval-augmented generation (RAG) context, which can typically be used for retrieving relevant grounding context and providing the grounding context to the LLM as input. Aspects described herein can provide post-editing of LLM output based on knowledge graphs extracted from the context and/or can provide infusing of the guided context, which includes relevant knowledge triplets, into a generic LLM. The knowledge graphs can typically include factual information in a semi-structured format, such as statements in subject, object, and relationship triples (e.g., Bill Gates, was, the CEO of Microsoft). In aspects described herein, such knowledge triplets and grounded context can be collected and maintained offline for the guided context (e.g., RAG).

Aspects described herein can improve performance of the LLMs by providing grounding to correct hallucinations. In addition, aspects described herein can provide improvements over pre-trained LLMs, which often lack relevant knowledge or cannot promptly adapt to changes in product databases or other updates. Moreover, aspects described herein can reduce constraints on maximum output length for the LLM by returning or generating only outputs related to both the prompt and the guided context. In addition, the generated output can be bounded based on the length of the guided context, and entities that are not relevant to the user prompts and guided context from the texts generated by an LLM can be eliminated from consideration for output. The described in terms of LLMs, the functionality described herein can be applied to other types of GAI models as well.

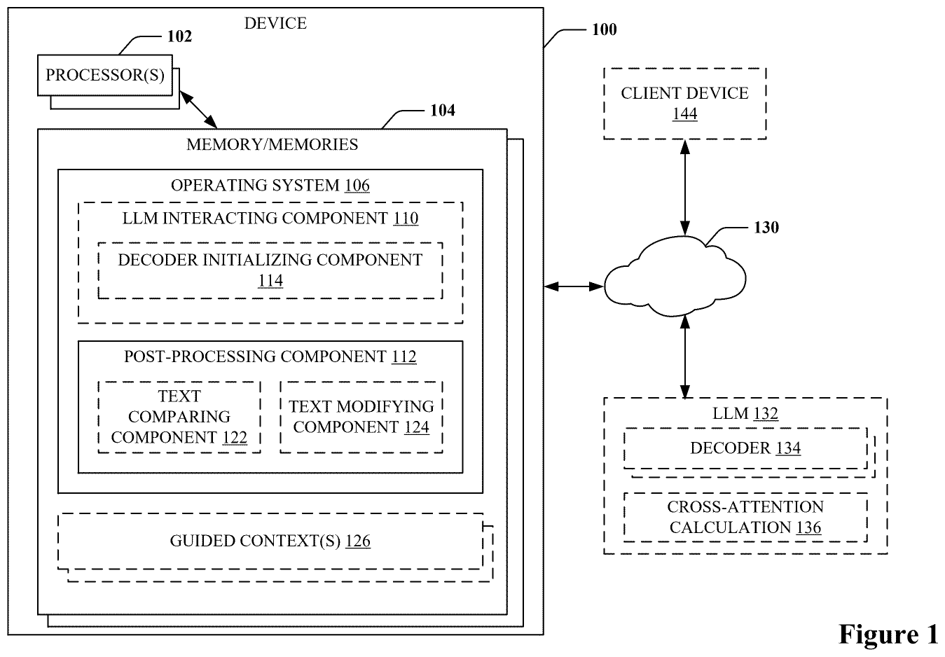

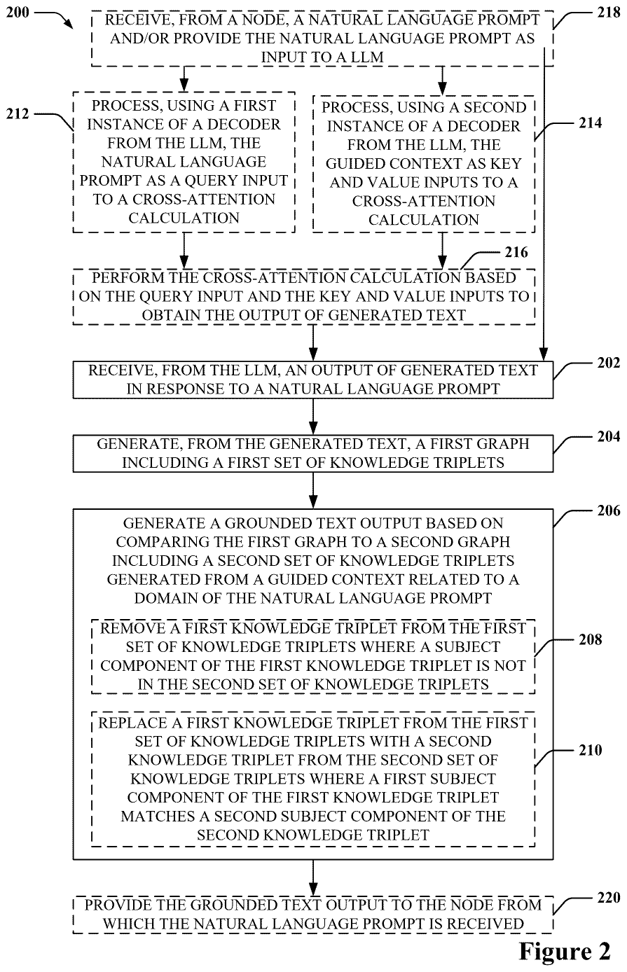

Turning now to FIGS. 1-4, examples are depicted with reference to one or more components and one or more methods that may perform the actions or operations described herein, where components and/or actions/operations in dashed line are generic and may be replaced with their variants. Although the operations described below in FIG. 2 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and/or a software component capable of performing the described actions or functions.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

FIG. 1 is a schematic diagram of an example of a device 100 (e.g., a computing device) for performing functions related to providing grounding for LLM generated text, in accordance with aspects described herein. In an example, device 100 can include one or more processors 102 and/or memory/memories 104 configured to execute or store instructions or other parameters related to providing an operating system 106, which can execute one or more applications or processes. For example, processor(s) 102 and memory/memories 104 may be separate components communicatively coupled by a bus (e.g., on a motherboard or other portion of a computing device, on an integrated circuit, such as a system on a chip (SoC), etc.), components integrated within one another (e.g., processor(s) 102 can include the memory/memories 104 as an on-board component), and/or the like.

Memory/memories 104 may store instructions, parameters, data structures, etc. for use/execution by processor(s) 102 to perform functions described herein. In another example, processor(s) 102 and/or memory/memories 104 can be distributed over multiple devices or physical computing nodes in a network (e.g., in a cloud-based computing platform) for providing the functions of the various components described herein.

In one example, the operating system 106 can execute one or more applications or processes, such as, but not limited to, an LLM interacting component 110 for providing a natural language prompt to an LLM 132 and/or receiving generated text output from the LLM 132, and/or a post-processing component 112 for modifying generated text output from the LLM 132 to remove hallucinations. LLM interacting component 110 can include a decoder initializing component 114 for initializing multiple decoders to guide text generation by the LLM 132. Post-processing component 112 can include a text comparing component 122 for comparing—e.g., using a graph algorithm—the generated text to a guided context to detect certain knowledge that is consistent or inconsistent between the generated text and the guided context, and/or a text modifying component 124 for modifying the generated text based on the comparison. In an example, device 100 can maintain one or more guided contexts 126 in memory/memories 104, such as RAG context(s), that can each include knowledge information (e.g., knowledge triplets) for a specific domain. In an example, the components 110, 112, 114, 122, and/or 124 can be included in, or implemented by, the device 100 and/or in other devices (e.g., in a cloud-computing environment or cloud-based computing platform), but are described herein as provided by the device 100 for ease of explanation. Indeed, in some examples, device 100 can be provided by multiple devices or nodes of a cloud-based computing platform.

In an example, device 100 can communicate with one or more other nodes or devices over a network 130, which can include one or more network connections, the Internet, etc. For example, device 100 can communicate with a LLM 132 for providing natural language prompts thereto and/or receiving corresponding generated text output therefrom, and/or a client device 144 for receiving the natural language prompt and/or providing the associated generated text output or modified generated text output (e.g., grounded text output), as described herein. For example, LLM 132 can include models such as ChatGPT or other large language models that are deep learning models trained on vast amounts of data to provide language processing tasks, such as language generation. The LLM 132 can include a model configured to learn statistical relationships from vast amounts of text during a self-supervised and/or semi-supervised training process. As described, given a natural language prompt, the LLM 132 can generate a text output based on training data and learned statistical relationships.

In an example, LLM interacting component 110 can provide the LLM 132 with a natural language prompt as input, and can receive, from the LLM 132, a generated text output based on the natural language prompt. In an example, post-processing component 112 can perform post-processing of the generated text output to create a grounded (e.g., modified) text output based on the natural language prompt. For example, text comparing component 122 can generate a first set of knowledge triplets and/or an associated graph for the generated text output received from the LLM 132 and a second set of knowledge triplets and/or an associated graph for a guided context 126. In an example, text comparing component 122 can compare the graphs using a graph algorithm, or associated sets of knowledge triplets, to determine whether to remove or replace/keep knowledge triplets (or related text) in the text output. For example, based on comparing the graphs, text comparing component 122 may remove knowledge triplets from the generated text output that do not have a subject component of a knowledge triplet in the guided context and/or replace knowledge triplets in the first set with knowledge triplets from the second set (or keep the knowledge triples in the first set) where the knowledge triplets have the same subject component. In this example, text modifying component 124 can generate a grounded text output based on the modified first set of knowledge triplets.

In another example, LLM 132 can include a decoder 134 (or multiple decoders) for generating the text output from the natural language prompt or other inputs. LLM 132 can also include cross-attention calculation 136 for calculating attention scores for generating the text output using additional information (e.g., an additional input sequence). In an example, decoder initializing component 114 can initialize a first instance of the decoder 134 to process the natural language prompt as a query input to the cross-attention calculation 136, and can initialize a second instance of the decoder 134 to process the guided context 126 as key and value inputs to the cross-attention calculation 136. LLM 132 can perform the cross-attention calculation 136 to generate the text output based on the query input and the key and value inputs to ensure accuracy of the text output.

FIG. 2 is a flowchart of an example of a method 200 for generating, for a natural language prompt, grounded text output from a LLM based on a guided context, in accordance with aspects described herein. For example, method 200 can be performed by a device 100 and/or one or more components thereof to facilitate generating query language queries and/or associated responses based on response templates, as described herein.

In method 200, at action 202, an output of generated text can be received from the LLM in response to a natural language prompt. In an example, LLM interacting component 110, e.g., in conjunction with processor(s) 102, memory/memories 104, operating system 106, etc., can interact with a LLM 132, which can include providing, to the LLM 132, a natural language prompt such to receive, from the LLM 132, an output of generated text in response to the natural language prompt. As described above, and further herein, in some examples, LLM interacting component 110 can receive the natural language prompt from, or the natural language prompt can otherwise be generated by, the client device 144 or other node. The LLM 132 can be substantially any LLM 132, as described, such as ChatGPT, such that the generated text output can be based on models trained on vast amounts of data. As described, however, the generated text output may be prone to hallucinations or other inaccuracies that can be caused in such LLMs based on the vast amount of data being used to train the LLM 132.

In method 200, at action 204, a first graph including a first set of knowledge triplets can be generated from the generated text. In an example, text comparing component 122, e.g., in conjunction with processor(s) 102, memory/memories 104, operating system 106, post-processing component 112, etc., can generate, from the generated text, the first graph including the first set of knowledge triplets. As described, for example, a knowledge triplet in the first set of one or more knowledge triplets can include a subject component, an object component, and a relationship component. For example, the generated text may include one or more sentences, and text comparing component 122 can generate the knowledge triplets for each of the one or more sentences, or portions of one or more sentences, that may correspond to a subject, object, and/or relationship inferred from the sentence.

In method 200, at action 206, a grounded text output can be generated based on comparing the first graph to a second graph including a second set of knowledge triplets generated from a guided context related to a domain of the natural language prompt. In an example, text modifying component 124, e.g., in conjunction with processor(s) 102, memory/memories 104, operating system 106, post-processing component 112, etc., can generate the grounded text output based on text comparing component 122 comparing the generated first graph to a second graph that includes a second set of knowledge triplets generated from the guided context (e.g., a guided context 126) that is related to a domain of the natural language prompt. For example, post-processing component 112 can select a guided context for the natural language input based on the natural language prompt itself (e.g., based on a domain inferred from the input), based on an application that supports providing the natural language prompt from a client device 144 to the LLM 132, etc. In any case, the guided context 126 can be associated with the domain used for grounding the text output generated by the LLM 132.

In an example, text comparing component 122 can create the second graph from the guided context 126 to include the second set of one or more knowledge triplets based on information in the guided context 126. In one example, the guided context may be in the form of a graph of knowledge triplets representing the domain-specific information. As described, for example, device 100 can maintain the guided context 126 to include information that is relevant and known as being factual for the domain and/or is obtained from intended known trusted sources of domain information, etc. As such, for example, the second set of knowledge triplets can include knowledge triplets that are known as factual and can be used to ground the text output generated by the LLM 132 by comparing with the knowledge triplet(s) from the text output generated by the LLM 132. In one example, text comparing component 122 can create the second graph for correcting each output or can create and store the second graph for subsequent output corrections, which may include periodically updating the second graph to include data from additional trusted sources, remove data from previous sources (e.g., where the information becomes stale), etc.

In one example, in generating the grounded text output at action 206, optionally at action 208, a first knowledge triplet can be removed from the first set of knowledge triplets where a subject component of the knowledge triplet is not in the second set of knowledge triplets. In an example, text modifying component 124, e.g., in conjunction with processor(s) 102, memory/memories 104, operating system 106, post-processing component 112, etc., can remove the first knowledge triplet from the first set of knowledge triplets where text comparing component 122 determines that a subject component of the first knowledge triplet is not in the second set of knowledge triplets. For example, this can indicate that the subject in the text output is not relevant to the domain, or otherwise that the guided context does not have enough information about the subject to ground the generated text output from the LLM 132. In such instances, text modifying component 124 can remove the knowledge triplet from the graph and/or can remote the subject or related sentence or sentence portion from the generated text output.

In another example, in generating the grounded text output at action 206, optionally at action 210, a first knowledge triplet from the first set of knowledge triplets can be replaced with a second knowledge triplet from the second set of knowledge triplets where a first subject component of the first knowledge triplet matches a second subject component of the second knowledge triplet. In an example, text modifying component 124, e.g., in conjunction with processor(s) 102, memory/memories 104, operating system 106, post-processing component 112, etc., can replace the first knowledge triplet from the first set of knowledge triplets with the second knowledge triplet from the second set of knowledge triplets where text comparing component 122 determines that the first subject component of the first knowledge triplet matches the second subject component of the second knowledge triplet. For example, this can indicate that the subject in the text output is found in the guided context, and the other information in the knowledge triplet (e.g., object or relationship) can be replaced with information found in the guided context to ground the generated text output from the LLM 132. Similarly, in an example, text modifying component 124 can alternatively determine to keep the first knowledge triplet in the set of knowledge triplets (e.g., rather than replacing with the second knowledge triplet) based on determining that the knowledge triplets match.

For example, whether the generated text from LLM 132 is factual can be determined by the domain source and the given guided context 126. In an example, LLM interacting component 110 can receive a natural language prompt (e.g., from client device 144 or otherwise) and can retrieve a related guided context 126 for use in generating a final text output for the prompt, as described herein. For example, the guided context 126 can be a mix of offline or web articles and database records, from which text comparing component 122 can generate knowledge triplets for ground verification and/or hallucination correction. In an example, for generated text output from LLM 132, potential hallucinations can be identified and corrected using knowledge triplets extracted from the guided context 126 (e.g., RAG context) and the generated text output. In particular, for example, text comparing component 122 can convert the extracted knowledge triplets from the guided context and the LLM output into graphs G and g, respectively, where each node v¿ represents either a subject or an object, and the relations between the subject and object serve as bi-directional edges connecting the two nodes. In one specific example, text comparing component 122 and/or text modifying component 124 can perform a process similar to the following pseudo-code to generate a grounded text output with hallucination removed:

```
1: Input: Ŷ, G
2: Output: Y*
3: Construct knowledge graph g = {tᵢ} from Ŷ
$4 : for knowledge triplet {t}_{i} = ( {v}_{i}^{s} , {v}_{i}^{o} , {r}_{i} ) in g do$
      $5 : if {v}_{i}^{s} not in G then$
6: Eliminate tᵢ from g and the associated sentence in Ŷ
7: else
8: Replace/keep tᵢ in Ŷ based on g and G
9: end if
10: end for
11: Assume Ĝ is the subgraph of G, and Ĝ contains all verified
      entities (nodes) in Ŷ
12: Y* = Ŷ
13: while Y* contains cycles do
14: Prune Ŷ to Y* until Y* is a minimum spanning tree of Ĝ.
15: end while
```

Using this process, for example, can allow for hallucination detection and correction for a given generated text Ŷ and the knowledge graph G extracted from the guided context 126. As a result, text modifying component 124 can produce a corrected/verified output Y*. A knowledge triplet t can be identified given a subject and a relation, or an object and a relation—e.g., the third component can be located and replaced when the entity or relation is incorrect in tᵢ, where tᵢ can include subject

$${v}_{i}^{s}$$

object

$${v}_{i}^{o}$$

and the relation rᵢ. This process, for example, can verify, replace, and prune triplets in Ŷ without increasing the number of nodes/entities. For instance, given a sentence in guided context 126: “M365 Business Basic is $7.2 dollars per user per month.”, text comparing component 122 can obtain knowledge triplet

$${t}_{i} = ( {v}_{i}^{s} , {v}_{i}^{o} , {r}_{i} )$$

as (M365 Business Basic, is, $7.2 dollars per user per month).

In another example, as LLM outputs can omit or introduce additional entities, multiple decoders can be used in the LLM 132 to process the natural language prompt and the guided context 126 in generating the text output, which can fundamentally alter the text generation process, as described herein. In method 200, optionally at Block 212, the natural language prompt can be processed, using a first instance of a decoder from the LLM, as a query input to a cross-attention calculation, which can be extended to a multi-head cross-attention block. In an example, decoder initializing component 114, e.g., in conjunction with processor(s) 102, memory/memories 104, operating system 106, LLM interacting component 110, etc., can process, using a first instance of the decoder 134 from the LLM 132, the natural language prompt as a query input to the cross-attention calculation. For example, decoder initializing component 114 can initialize the first instance of the decoder 134 of the LLM 132 and/or provide as input, to the first instance of the decoder 134, the natural language prompt and/or corresponding tokens of the natural language prompt.

In method 200, optionally at Block 214, the guided context can be processed, using a second instance of a decoder from the LLM, as key and value inputs to the cross-attention calculation. In an example, decoder initializing component 114, e.g., in conjunction with processor(s) 102, memory/memories 104, operating system 106, LLM interacting component 110, etc., can process, using a second instance of the decoder 134 from the LLM 132, the guided context as key and value inputs to the cross-attention calculation. For example, decoder initializing component 114 can initialize the second instance of the decoder 134 of the LLM 132 and/or provide as input, to the second instance of the decoder 134, the guided context 126 related to the natural language prompt and/or corresponding tokens of the guided context 126.

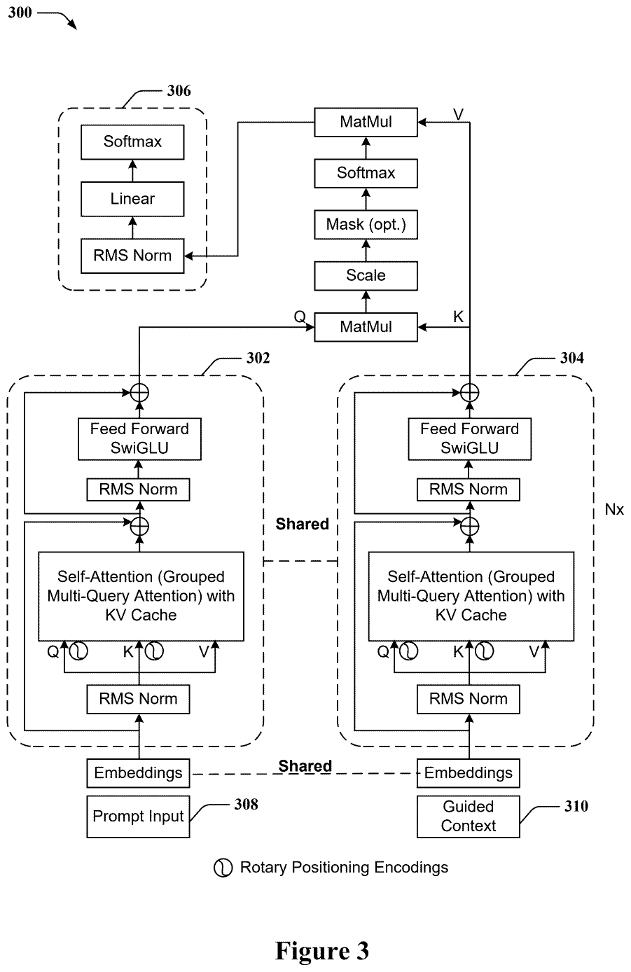

In method 200, optionally at Block 216, the cross-attention calculation can be performed based on the query input and the key and value inputs to obtain the output of generated text. In an example, LLM 132, e.g., in conjunction with processor(s), memory/memories, etc. thereof, can perform the cross-attention calculation 136 based on the query input and key and value inputs from the multiple instances of decoder 134, as described herein. For example, in addition to the contextual embeddings used in transformers of LLMs (e.g., of LLM 132), decoder initializing component 114 can embed guidance text (e.g., text from guided context 126) and apply a cross-attention calculation using the hidden states of the two decoders (or decoder instances of decoder 134). In this regard, for example, grounding/context source embeddings in one decoder and the user prompt in the other decoder can be provided, with both decoders sharing weights of the LLM 132. The LLM 132 can apply cross-attention CROSSATTN (Hₚ, H_{g}) by taking the hidden state Hₚ of the prompt module as the query, from the first decoder instance, and the hidden state H_{g} of the guided context module as the key and value, from the second decoder instance. An example is shown in FIG. 3.

FIG. 3 illustrates an example of a LLM 300 that utilizes multiple decoders to generate text output, in accordance with aspects described herein. For example, the LLM can be a pre-trained generic LLM, with the capability of using dual decoders and a cross-attention calculation to generate output for natural language text input. In an example, LLM 300 can be or can be similar to LLM 132. In this example, LLM 300 can include dual decoders (e.g., two instances of decoder 134) 302 and 304. For example, decoder 302 can generate a query input (Q) based on the natural language prompt (e.g., prompt input 308 for decoder 302), which may be received from a client device 144 or other device, as described. In addition, for example, decoder 304 can generate a key input (K) and value input (V) based on the guided context 310 (e.g., one or more guided context(s) 126). In an example, the prompt inputs 308 can be generated as multiple tokens (e.g., token-by-token), where the tokens can correspond to words or phrases in the natural language prompt input (e.g., received from a client device 144 or other device).

The decoders 302 and/or 304 can include a root mean square layer normalization (RMS Norm) and a position-wide feed-forward network with self-gated linear units (Feed Forward SwiGLU) as activation functions. The Q and K outputs can be provided to matrix multiplication (MatMul), a scale by dimension of K (e.g., excluding tokens in the padding mask (Mask)), and a Softmax activation function can be applied to calculate the weights on V. In this regard, for example, the guided context 310 can contribute to the cross-attention computation CROSSATTN(Hₚ,H_{g}) only. The components in 306 can then autoregressively generate output texts, including linear neural network layers (Linear), and Softmax activation function. The components shown in 302 and 306 can be fine-tuned transformer block components for the LLM 300, with the second decoder 304 added to provide ground-truth features for use by the LLM 300. During the inference stage, the guided context 310 can be the same as the RAG context. LLM 300 can augment the RAG context by randomly adding additional content (e.g., shuffled from other RAG results from different prompts) as the guided context during finetuning. In an example, this model can guide text generation without significantly increasing the model size as the same LLM 132 is shared with different inputs and decoders, and only one set of the decoder weights being used to finetune the model.

In an example, the LLM interacting component 110 can receive natural language prompts from a client device 144 or other node, provide the natural language prompt to the LLM 132, and receive the LLM output from LLM 132. Post-processing component 112 can modify the LLM output, as described herein, and return the modified LLM output to the client device 144 or other node that provided the natural language prompt to LLM interacting component 110.

Referring back to FIG. 2, in method 200, optionally at Block 218, a natural language prompt can be received from a node and/or the natural language prompt can be provided as input to an LLM. In an example, LLM interacting component 110, e.g., in conjunction with processor(s) 102, memory/memories 104, operating system 106, etc., can receive, from the node (e.g., client device 144 or other node), the natural language prompt and/or can provide the natural language prompt as input to a LLM (e.g., LLM 132). As described, for example, LLM interacting component 110 can provide the natural language prompt to the LLM 132, where the LLM 132 can use multiple decoders to provide a grounded text output and/or where post-processing component 112 can apply post-processing of the LLM 132 output to obtain the grounded text output using one or more of the mechanisms described above. In one example, LLM interacting component 110 can receive the output of generated text at action 202 from the LLM 132 in response to providing the natural language prompt, as received from the node, to the LLM 132.

In method 200, optionally at Block 220, the grounded text output can be provided to the node from which the natural language prompt is received. In an example, LLM interacting component 110, post-processing component 112, etc., e.g., in conjunction with processor(s) 102, memory/memories 104, operating system 106, etc., can provide the grounded text output to the node from which the natural language prompt is received (e.g., client device 144 or other node).

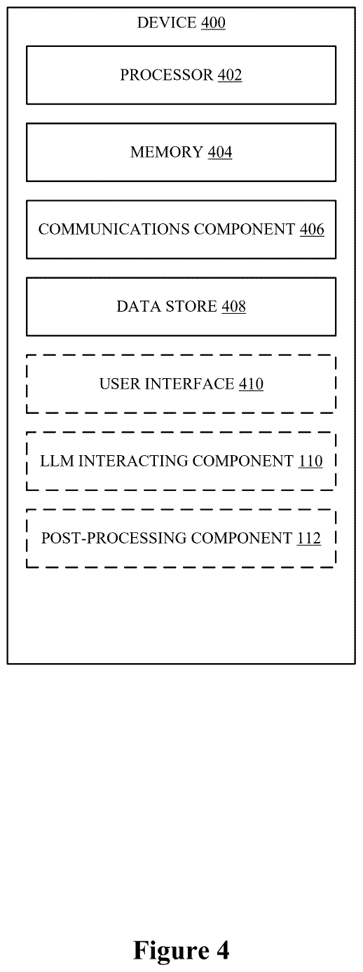

FIG. 4 illustrates an example of device 400 including additional optional component details as those shown in FIG. 1. In one aspect, device 400 may include processor 402, which may be similar to processor(s) 102 for carrying out processing functions associated with one or more of components and functions described herein. Processor 402 can include a single or multiple set of processors or multi-core processors. Moreover, processor 402 can be implemented as an integrated processing system and/or a distributed processing system.

Device 400 may further include memory 404, which may be similar to memory/memories 104 such as for storing local versions of operating systems (or components thereof) and/or applications being executed by processor 402, such as a LLM interacting component 110, post-processing component 112, etc. Memory 404 can include a type of memory usable by a computer, such as random access memory (RAM), read only memory (ROM), tapes, magnetic discs, optical discs, volatile memory, non-volatile memory, and any combination thereof.

Further, device 400 may include a communications component 406 that provides for establishing and maintaining communications with one or more other devices, parties, entities, etc. utilizing hardware, software, and services as described herein. Communications component 406 may carry communications between components on device 400, as well as between device 400 and external devices, such as devices located across a communications network and/or devices serially or locally connected to device 400. For example, communications component 406 may include one or more buses, and may further include transmit chain components and receive chain components associated with a wireless or wired transmitter and receiver, respectively, operable for interfacing with external devices.

Additionally, device 400 may include a data store 408, which can be any suitable combination of hardware and/or software, that provides for mass storage of information, databases, and programs employed in connection with aspects described herein. For example, data store 408 may be or may include a data repository for operating systems (or components thereof), applications, related parameters, etc.) not currently being executed by processor 402. In addition, data store 408 may be a data repository for LLM interacting component 110, post-processing component 112, and/or one or more other components of the device 400.

Device 400 may optionally include a user interface component 410 operable to receive inputs from a user of device 400 and further operable to generate outputs for presentation to the user. User interface component 410 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, user interface component 410 may include one or more output devices, including but not limited to a display, a speaker, a haptic feedback mechanism, a printer, any other mechanism capable of presenting an output to a user, or any combination thereof.

Some further example aspects are provided below.

Aspect 1 is a method for grounding text generation output from a generative artificial intelligence (GAI) model that includes receiving, from the GAI model, an output of generated text in response to a natural language prompt, generating, from the generated text, a first graph including a first set of knowledge triplets, and generating a grounded text output based on comparing the first graph to a second graph including a second set of knowledge triplets generated from a guided context related to a domain of the natural language prompt.

In Aspect 2, the method of Aspect 1 includes where generating the grounded text output includes removing a first knowledge triplet from the first set of knowledge triplets where a subject component of the first knowledge triplet is not in the second set of knowledge triplets.

In Aspect 3, the method of any of Aspects 1 or 2 includes where generating the grounded text output includes replacing a first knowledge triplet from the first set of knowledge triplets with a second knowledge triplet from the second set of knowledge triplets where a first subject component of the first knowledge triplet matches a second subject component of the second knowledge triplet.

In Aspect 4, the method of any of Aspects 1 to 3 includes processing, using a first instance of a decoder from the GAI model, the natural language prompt as a query input to a cross-attention calculation, processing, using a second instance of the decoder from the GAI model, the guided context as key and value inputs to the cross-attention calculation, and performing the cross-attention calculation based on the query input and the key and value inputs to obtain the output of generated text.

In Aspect 5, the method of Aspect 4 includes where the first instance of the decoder and the second instance of the decoder share all weights.

In Aspect 6, the method of any of Aspects 4 or 5 includes where performing the cross-attention calculation is based on a first hidden state of a first output of the first instance of the decoder and a second hidden state of a second output of the second instance of the decoder.

In Aspect 7, the method of any of Aspects 4 to 6 includes where the first instance of the decoder processes multiple individual tokens from the natural language prompt.

Aspect 8 is an apparatus including one or more processors, one or more memories coupled with the one or more processors, and instructions stored in the one or more memories and operable, when executed by the one or more processors, to cause the apparatus to perform any of the methods of Aspects 1 to 7.

Aspect 9 is an apparatus for including means for performing any of the methods of Aspects 1 to 7.

Aspect 10 is one or more computer-readable media including code executable by one or more processors, the code including code for performing any of the methods of Aspects 1 to 7.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly included and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A computer-implemented method for grounding text generation output from a generative artificial intelligence (GAI) model, comprising:
receiving, from a node, a natural language prompt;
providing, to the GAI model, the natural language prompt as input;
receiving, from the GAI model, an output of generated text in response to a natural language prompt;
generating, from the generated text, a first graph including a first set of knowledge triplets, wherein each knowledge triplet includes a subject, an object, and a relationship between the subject and the object indicated in the generated text;
generating a grounded text output based on comparing the first graph to a second graph including a second set of knowledge triplets generated from a guided context related to a domain of the natural language prompt, wherein generating the grounded text output includes removing a first knowledge triplet from the first set of knowledge triplets where a subject component of the first knowledge triplet is not in the second set of knowledge triplets; and
providing the grounded text output to the node.

2. The computer-implemented method of claim 1, wherein generating the grounded text output includes replacing a first knowledge triplet from the first set of knowledge triplets with a second knowledge triplet from the second set of knowledge triplets where a first subject component of the first knowledge triplet matches a second subject component of the second knowledge triplet.

3. The computer-implemented method of claim 1, further comprising:
processing, using a first instance of a decoder from the GAI model, the natural language prompt as a query input to a cross-attention calculation;
processing, using a second instance of the decoder from the GAI model, the guided context as key and value inputs to the cross-attention calculation; and
performing the cross-attention calculation based on the query input and the key and value inputs to obtain the output of generated text.

4. The computer-implemented method of claim 3, wherein the first instance of the decoder and the second instance of the decoder share all weights.

5. The computer-implemented method of claim 3, wherein performing the cross-attention calculation is based on a first hidden state of a first output of the first instance of the decoder and a second hidden state of a second output of the second instance of the decoder.

6. The computer-implemented method of claim 3, wherein the first instance of the decoder processes multiple individual tokens from the natural language prompt.

7. The computer-implemented method of claim 1, wherein the GAI model is a large language model.

8. A device for grounding text generation output from a generative artificial intelligence (GAI) model, comprising:
one or more memories storing instructions; and
one or more processors coupled to the one or more memories and configured to execute the instructions to:
receive, from the GAI model, an output of generated text in response to a natural language prompt;
generate, from the generated text, a first graph including a first set of knowledge triplets, wherein each knowledge triplet includes a subject, an object, and a relationship between the subject and the object indicated in the generated text, wherein the one or more processors are configured to execute the instructions to generate the grounded text output at least in part by replacing a first knowledge triplet from the first set of knowledge triplets with a second knowledge triplet from the second set of knowledge triplets where a first subject component of the first knowledge triplet matches a second subject component of the second knowledge triplet; and
generate a grounded text output based on comparing the first graph to a second graph including a second set of knowledge triplets generated from a guided context related to a domain of the natural language prompt.

9. The device of claim 8, wherein the one or more processors are configured to execute the instructions to generate the grounded text output at least in part by removing a first knowledge triplet from the first set of knowledge triplets where a subject component of the first knowledge triplet is not in the second set of knowledge triplets.

10. The device of claim 8, wherein the one or more processors are configured to execute the instructions to:
process, using a first instance of a decoder from the GAI model, the natural language prompt as a query input to a cross-attention calculation;
process, using a second instance of the decoder from the GAI model, the guided context as key and value inputs to the cross-attention calculation; and
perform the cross-attention calculation based on the query input and the key and value inputs to obtain the output of generated text.

11. The device of claim 10, wherein the first instance of the decoder and the second instance of the decoder share all weights.

12. The device of claim 10, wherein the one or more processors are configured to execute the instructions to perform the cross-attention calculation based on a first hidden state of a first output of the first instance of the decoder and a second hidden state of a second output of the second instance of the decoder.

13. The device of claim 10, wherein the first instance of the decoder processes multiple individual tokens from the natural language prompt.

14. The device of claim 8, wherein the GAI model is a large language model.

15. A non-transitory computer-readable medium storing instructions thereon that, when executed by at least one computing device, cause the at least one computing device to perform operations for grounding text generation output from a generative artificial intelligence (GAI) model, comprising:
receiving, from the GAI model, an output of generated text in response to a natural language prompt;
generating, from the generated text, a first graph including a first set of knowledge triplets, wherein each knowledge triplet includes a subject, an object, and a relationship between the subject and the object indicated in the generated text; and
generating a grounded text output based on comparing the first graph to a second graph including a second set of knowledge triplets generated from a guided context related to a domain of the natural language prompt.

16. The non-transitory computer-readable medium of claim 15, the operations comprising generating the grounded text output at least in part by removing a first knowledge triplet from the first set of knowledge triplets where a subject component of the first knowledge triplet is not in the second set of knowledge triplets.

17. The non-transitory computer-readable medium of claim 15, the operations comprising generating the grounded text output at least in part by replacing a first knowledge triplet from the first set of knowledge triplets with a second knowledge triplet from the second set of knowledge triplets where a first subject component of the first knowledge triplet matches a second subject component of the second knowledge triplet.

18. The non-transitory computer-readable medium of claim 15, the operations further comprising:
processing, using a first instance of a decoder from the GAI model, the natural language prompt as a query input to a cross-attention calculation;
processing, using a second instance of the decoder from the GAI model, the guided context as key and value inputs to the cross-attention calculation; and
performing the cross-attention calculation based on the query input and the key and value inputs to obtain the output of generated text.

19. The non-transitory computer-readable medium of claim 18, wherein the first instance of the decoder and the second instance of the decoder share all weights.

20. The non-transitory computer-readable medium of claim 18, the operations comprising performing the cross-attention calculation based on a first hidden state of a first output of the first instance of the decoder and a second hidden state of a second output of the second instance of the decoder.
